(19) United States
(12) Patent Application Publication
(10) Pub. No.: US 2020/0076272 A1
(43) Pub. Date: Mar. 5, 2020

(54) METHOD FOR CAPTURING PRESSURE AND GENERATING ELECTRICITY FROM SHOCKWAVES CREATED BY LIGHTNING/ELECTRICAL ARCING

(71) Applicant: Carl Swanson, Bozeman, MT (US)

(72) Inventor: Carl Swanson, Bozeman, MT (US)

(21) Appl. No.: 16/507,881

(22) Filed: Jul. 10, 2019

Related U.S. Application Data
(60) Provisional application No. 62/698,027, filed on Jul. 14, 2018.

(51) Int. Cl. H02K 7/18; F03G 7/04

(52) U.S. Cl. CPC H02K 7/1823; F03G 7/04

(57) ABSTRACT

A method for capturing shockwaves from high voltage arcs from both human and natural sources and generating additional power therefrom is disclosed. The invention is comprised of three main parts: a first part being a shockwave chamber with a conductive channel having a gap therebetween; a second part being a sealed compression chamber with a pressure reduction system; and a third part being a pressure turbine. When the aforementioned high voltage arcs across the gap in the conductive material, the shockwave is captured within the shockwave chamber. The shockwave is then stepped down by the pressure reduction system and is then transferred to the turbine which rotates to provides additional mechanical energy.

### CROSS-REFERENCE TO RELATED APPLICATIONS

This application claims the benefit of U.S. Provisional Patent Application No. 62/698,027, filed on Jul. 14, 2018.

### FIELD OF THE INVENTION

The present invention generally relates to power generation. More specifically, it defines a method for capturing and harnessing pressure waves from arcs generated by both human and natural high voltage sources.

### BACKGROUND AND DESCRIPTION OF THE PRIOR ART

Lightning is a violent and sudden electrostatic discharge where two, electrically-charged regions in the atmosphere temporarily equalize themselves during a thunderstorm. Lightning strikes can generate a wide range of high voltage from the very hot plasma created by the electron flow, including visible light in the form of black-body radiation. Thunder is the sound formed by the shock waves formed as gaseous molecules experience a rapid pressure increase. The amount of energy from a lightning strike alone is staggering. Each lightning strike can generate as much as five billion joules and, over a year's time of continuous strikes, can average around 490,000,000,000 kW of electricity if captured properly. In other words, all of the world's energy needs could be captured in approximately one-week of lightning strikes. In an effort to begin harnessing the energy of lightning, just a few researchers have begun developing the means to capture and translate such high voltage into usable energy sources. European Patent Nos. GB2502633A and WO2013178973A1 granted to Al-Rubb teach of lightning capture methods that rely on steam pressure to drive turbines for additional energy. Chinese patent CN101296536A granted to Stone discloses a method of capturing and accumulating electrical energy from lightning strikes into long-term battery storage. However, no patents were found in the prior art that harness the power of pressure waves associated with arcs from lightning and human sources of high voltage.

### SUMMARY OF THE INVENTION

The device herein disclosed and described provides a solution to the shortcomings in the prior art through the disclosure of a system and method for generating power from pressures associated with high-voltage arcing. An object of the invention is to generate useful mechanical energy from existing high voltage as it arcs across conductive material.

Another object of this invention is to provide a means of capturing the pressure from a shockwave generated during high voltage arcing. The apparatus includes a high-pressure accumulation chamber to retain the shock wave.

Another object of the aforementioned invention is to provide a system to generate a shock wave from a high voltage source. The invention includes a conductive line having a gap therein to allow electricity to arc. When the arc is established, a very high-pressure shockwave is also generated within the local atmosphere.

Another object of the aforementioned invention is to provide a system to reduce the shockwave to a manageable pressure and transfer said shockwave pressure into a turbine.

Another object of the invention is to provide a means to convert pressure energy from the resulting shockwave into circular, mechanical energy by means of a pressure turbine connected to said pressure accumulation chamber.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

The preferred embodiment of the instant inventions teaches a device for capturing and storing energy comprising: an electrically conductive channel; a shockwave chamber through which said electrically conductive channel with gap is situated; a compression chamber connected to said shockwave chamber; and a turbine connected to said compression chamber.

The above embodiment can be further modified by defining that said electrically conductive channel has a gap therein.

The above embodiment can be further modified by defining that an electric generator is attached to said turbine.

The above embodiment can be further modified by defining that a relief valve that separates said shockwave chamber from said compression chamber

The above embodiment can be further modified by defining that a relief valve that separates said compression chamber and said turbine.

The above embodiment can be further modified by defining that a high-pressure receiving tank is proximate said compression chamber in the place of said turbine.

The above embodiment can be further modified by defining that a relief valve separates said compression chamber from said high-pressure receiving tank.

An alternate embodiment of instant inventions provides for a device that provides thrust to a propulsion system nozzle utilizing lightning or human-generated electricity comprising: a propulsion system having a top and a bottom; a propulsion system nozzle proximate said bottom of said propulsion system; an electrically conductive channel having a gap extending through said propulsion system from said top through said bottom and through said propulsion system nozzle; and a compression chamber connected to said propulsion system.

A second alternate embodiment of the instant invention provides for a method for generating energy comprising the steps of: utilizing an electrically conductive channel to attract electricity; providing a shockwave chamber around said electrically conductive channel; conducting electricity through said electrically conductive channel; arcing electricity across a gap in said electrically conductive channel; generating a shockwave in said gap; reducing said shockwave through a compression chamber; and turning a turbine.

The above embodiment can be further modified by defining that human-generated electricity is used in the place of lightning.

The above embodiment can be further modified by defining that an electrical generator is attached to said turbine.

The above embodiment can be further modified by defining that a high-pressure receiving tank is used in the place of said turbine.

The above embodiment can be further modified by defining that there is a relief valve that separates said shockwave chamber from said compression chamber

The above embodiment can be further modified by defining that a relief valve separates said compression chamber and said turbine.

The above embodiment can be further modified by defining that a relief valve separates said compression chamber from said high-pressure receiving tank.

Yet another embodiment of the instant invention provides for a device for providing thrust to a projectile within a projectile-launching system utilizing lightning or human-generated electricity comprising: a projectile-launching system having a top and a bottom; a projectile located inside of said projectile-launching system between said top and said bottom; an electrically conductive channel having a gap extending through said projectile-launching system from said top through said bottom and proximate said projectile; and a compression chamber connected to said projectile-launching system.

The above embodiment can be further modified by defining that said projectile rests on a mesh platform.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the device of the instant invention.

FIG. 2 illustrates a rear cross-sectional view of the embodiment of the instant invention as illustrated in FIG. 1.

FIG. 3 shows an illustrative flow chart showing the process of utilization of the device of the instant invention.

FIG. 4 illustrates a perspective view of an alternate embodiment the device of the instant invention.

FIG. 5 shows a rear cross-sectional view of the alternate embodiment of the instant invention as illustrated in FIG. 4.

FIG. 6 shows a second alternate embodiment of the instant invention which is a scaled up tower version for industrial use.

FIG. 7A shows a side view of a third alternate embodiment which is a propulsion embodiment illustratively providing thrust to a propulsion system nozzle.

FIG. 7B shows the interior portion of the view shown in FIG. 7A.

FIG. 8 is a side view of a fourth alternate embodiment of the instant invention providing for an external thrust system for a projectile-launching system.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

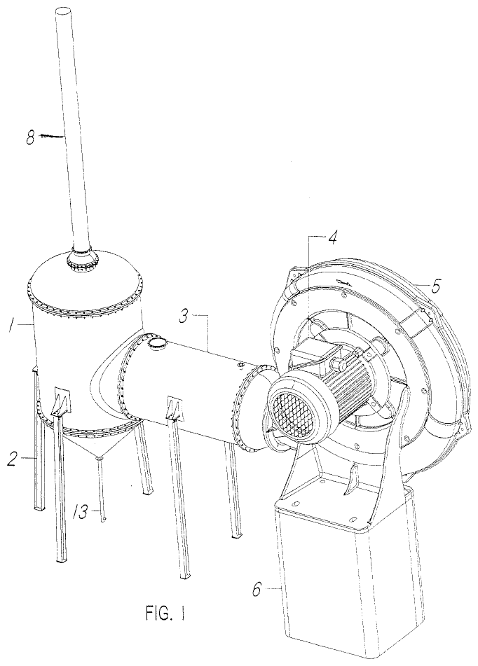

FIG. 1 showing a perspective view of the invention having three main parts: a first part being a shockwave chamber 1, an electrically conductive channel 8, a compression chamber 3 and a turbine 5 with onboard electrical generator 4. shockwave chamber 1 and compression chamber 3 (and associated flange connections) being made of or covered in a rigid, nonconductive material, such as, but not limited to, HDPE and the like and having a thickness to be able to withstand a lightning shockwave, which can reach pressures of more than 10-100 atmospheres. Compression chamber 3 walls also being electrically insulated with a nonconductive material including but not limited to HDPE and the like. The figure also showing said compression chamber 3 being fixedly connected to turbine 5 and generator 4. Said turbine 5 including but not limited to a Tesla turbine or a transonic turbine therein. All of the aforementioned main parts being anchored by means of legs 2 and stand 6 also being comprised of a rigid material such as HDPE and the like. Embodiments of the invention may contain a medium to absorb and transmit the shockwave, including but not limited to various forms and mixtures of expansion gases or heated fluids therein.

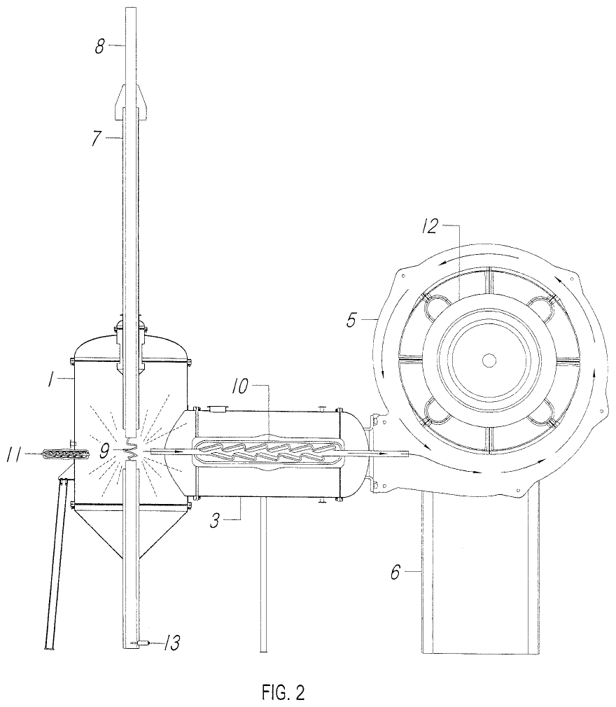

FIG. 2 shows a section view of the invention with compression chamber 1 having a electrically conductive channel 8 disposed vertically and proximally within said compression chamber 1. The electrically conductive channel 8 is used for receiving conventional human-generated electricity or electricity from a lightning strike and being made of a highly-conductive material such as but not limited to copper and the like and is protected by electrical insulation 7. Said electrically conductive channel 8 being positioned high in the sky (up to but not limited to several hundred feet) providing a ‘path of least resistance’ when exposed to an unstable air mass there above. Within shockwave chamber 1, the electrically conductive channel 8 has a gap allowing high-voltage to generate an arc 9 thereacross which in turn generates an extremely high-pressure shockwave as it passes through said electrically conductive channel 8 to ground 13 safely there below. During operation, the high-pressure shockwave is transmitted from shockwave chamber 1 into compression chamber 3 and reduced by reduction valve 10 comprised of but not limited to a Tesla valve and the like. The shockwave chamber also has an emergency relief valve 11 that may also be comprised of, but not limited to, a Tesla valve and the like. Once the shockwave pressure has been reduced, it is transmitted into the turbine 5 comprised of, but not limited to, a conventional turbine, a transonic turbine, a Tesla turbine, etc., and whereby the kinetic energy is transformed into rotary mechanical energy to drive said conventional, onboard generator 4 thereon.

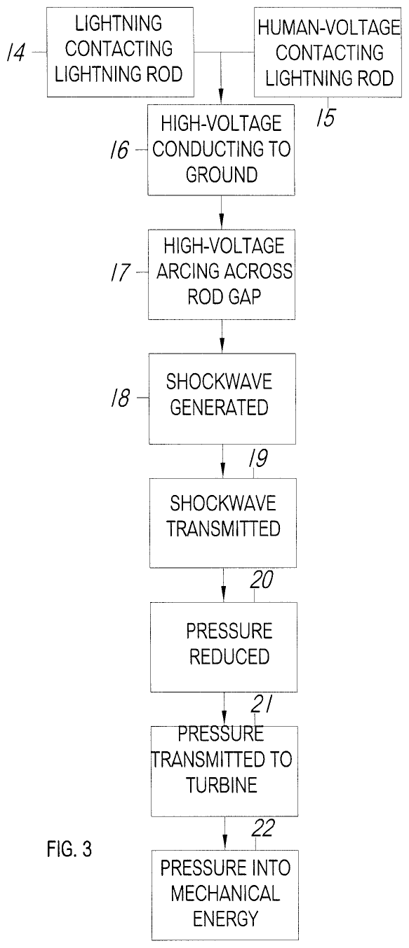

FIG. 3 shows a representative view of the invention process. In step 14 and 15 high-voltage electricity making contact with the electrically conductive channel and traveling downward into the apparatus to be grounded in step 16. While being conducted through the channel, said high-voltage arcing across the channel gap in step 17 resulting in a shockwave in the conduction chamber 1 in step 18 that is transmitted into the pressure reduction chamber 19. After pressure reduction in stage 20, the remaining pressure is transmitted to the turbine in step 22 whereby said pressure is converted into mechanical energy in step 22. Other embodiments may include but not be limited to allowing mechanical energy to be converted into hydraulic drives, gear train drives and the like.

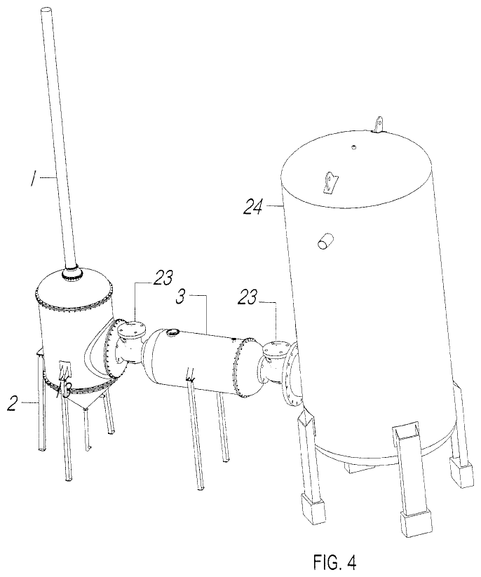

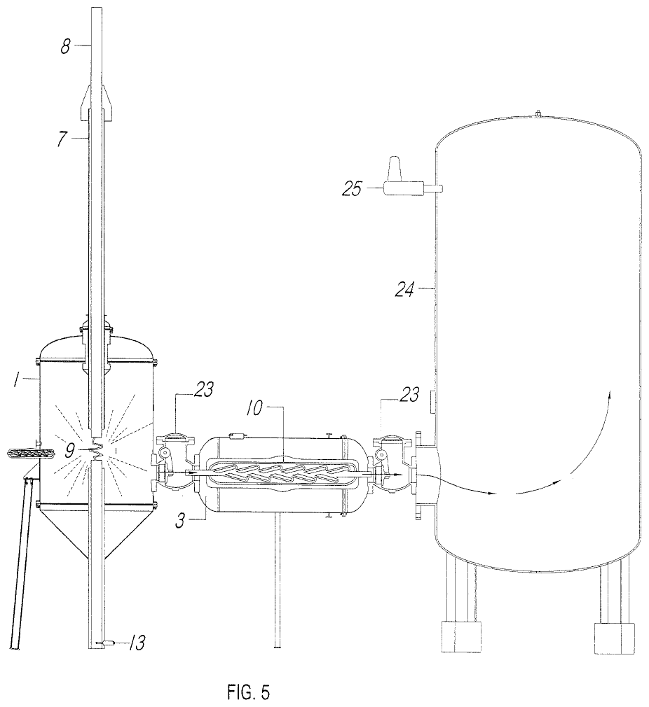

FIG. 4 and FIG. 5 show a perspective view and a section view, respectively, of another embodiment of the invention having at least, but not limited to, two check valves 23 orientated to prevent pressure from moving back into conduction chamber 1 and a high-pressure receiving tank 24. Said receiving tank 24 being made of a rigid material such as, but not limited to, HDPE and the like and of a thickness to contain and store high-pressure energy from shockwaves for an extended period of time therein. The receiving tank 24 also having an emergency relief safety valve 25.

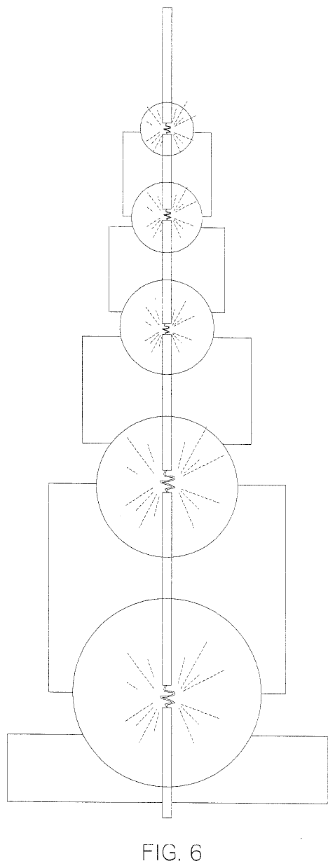

It is to be noted that the invention is scalable from the views shown in FIGS. 1-5. That is, the device can be a large tower suitable for industrial uses, such as cell towers, skyscrapers and electrical utility companies. FIG. 6 shows a representative view of the tower embodiment of the instant invention.

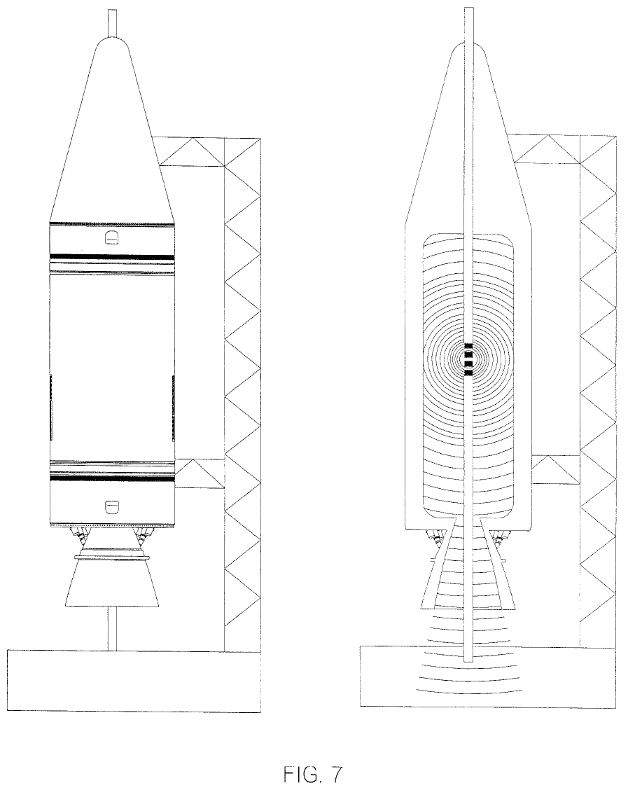

Additionally, the device of the instant invention can be used to provide propulsion to provide thrust to a propulsion system nozzle. FIGS. 7A and 7B show side views of this embodiment.

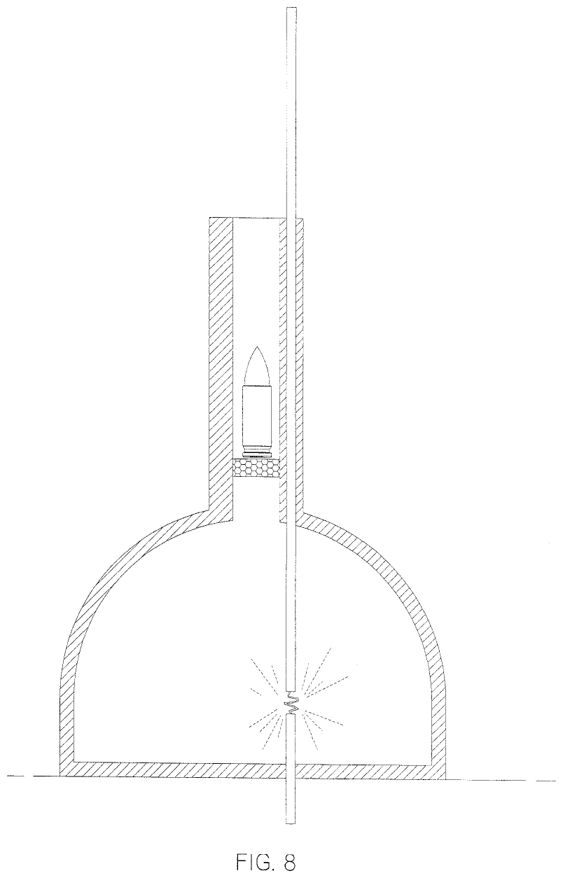

FIG. 8 illustrates yet another embodiment of the technology of the instant invention wherein the energy harnessed from the electrically conductive channel with the gap therethrough providing thrust to a projectile-launching system and ejecting a projectile that sits proximate to said electrically conductive channel such that the energy produced therein is accessible and used to eject the projectile from a projectile-launching system.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, duplications, and variations may be made by those skilled in the art without departing from the spirit or scope of the invention.

What is claimed is:

1. A device for capturing and storing energy comprising:
an electrically conductive channel;
a shockwave chamber through which said electrically conductive channel with gap is situated;
a compression chamber connected to said shockwave chamber; and
a turbine connected to said compression chamber.

2. The device as defined in claim 1 wherein said electrically conductive channel has a gap therein.

3. The device as defined in claim 1 further comprising an electric generator attached to said turbine.

4. The device as defined in claim 1 further comprising a relief valve that separates said shockwave chamber from said compression chamber

5. The device as defined in claim 1 further comprising a relief valve that separates said compression chamber and said turbine.

6. The device as defined in claim 1 wherein a high-pressure receiving tank is proximate said compression chamber in the place of said turbine.

7. The device as defined in claim 6 wherein a relief valve separates said compression chamber from said high-pressure receiving tank.

8. A device for providing thrust to a propulsion system nozzle utilizing lightning or human-generated electricity comprising:
a propulsion system having a top and a bottom;
a propulsion system nozzle proximate said bottom of said propulsion system;
an electrically conductive channel having a gap extending through said propulsion system from said top through said bottom and through said propulsion system nozzle; and
a compression chamber connected to said propulsion system.

9. A method for generating energy comprising the steps of:
utilizing an electrically conductive channel to attract electricity;
providing a shockwave chamber around said electrically conductive channel;
conducting electricity through said electrically conductive channel;
arcing electricity across a gap in said electrically conductive channel;
generating a shockwave in said gap;
reducing said shockwave through a compression chamber; and
turning a turbine.

10. The method as defined in claim 9 wherein human-generated electricity is used in the place of lightning.

11. The method as defined in claim 9 wherein an electrical generator is attached to said turbine.

12. The method as defined in claim 9 wherein a high-pressure receiving tank is used in the place of said turbine.

13. The method as defined in claim 9 further comprising a relief valve that separates said shockwave chamber from said compression chamber

14. The method as defined in claim 9 further comprising a relief valve that separates said compression chamber and said turbine.

15. The method as defined in claim 12 wherein a relief valve separates said compression chamber from said high-pressure receiving tank.

16. A device for providing thrust to a projectile within a projectile-launching system utilizing lightning or human-generated electricity comprising:
a projectile-launching system having a top and a bottom;
a projectile located inside of said projectile-launching system between said top and said bottom;
an electrically conductive channel having a gap extending through said projectile-launching system from said top through said bottom and proximate said projectile; and
a compression chamber connected to said projectile-launching system.

17. The device as defined in claim 16 wherein said projectile rests on a mesh platform.
